(19) United States
(12) Patent Application Publication
(10) Pub. No.: US 2025/0042711 A1
(43) Pub. Date: Feb. 6, 2025

(54) SELF-CLEANING SYSTEM FOR BEVERAGE DISPENSERS

(71) Applicant: LNJ Group, LLC, Glen Head, NY (US)

(72) Inventor: Derrick Du, San Bruno, CA (US)

(73) Assignee: LNJ Group, LLC, Glen Head, NY (US)

(21) Appl. No.: 18/230,655

(22) Filed: Aug. 6, 2023

(51) Int. Cl. B67D 1/07; B67D 1/08; B67D 1/10

(52) U.S. Cl. CPC B67D 1/07; B67D 1/0878; B67D 1/10

(57) ABSTRACT

A beverage dispensing system comprising a beverage reservoir, wherein the beverage reservoir comprises a container coupled to a cooling system. The beverage dispensing system further comprising a beverage pump coupled to the beverage reservoir, wherein the beverage pump is configured to pump contents of the beverage reservoir to the cooling system. The beverage dispensing system further comprising a sensor configured to detect whether the beverage reservoir is empty, a cleaning reservoir comprising a container, and a cleaning pump coupled to the cleaning reservoir, wherein the cleaning pump is configured to pump contents of the cleaning reservoir to the beverage reservoir. The beverage dispensing system further comprising an liquid sensor configured to detect whether the beverage reservoir is empty, and a programmable circuit board configured to receive a signal from the liquid sensor and control operation of the beverage pump based on the signal.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to the field of beverage appliances, and in particular, a self-cleaning system and method of cleaning beverage dispensers.

### Description of the Related Art

Beverage makers and dispensers for home use have become very popular. Such devices may, for example, prepare or dispense varieties of coffee, tea, soda, juice, wine, beer, and the like. After each beverage dispensing action, residues of ingredients may remain in these devices. Beverage makers that dispense a variety of beverages often include delivery lines and other components that are prone to cross-contamination unless they are periodically cleaned/flushed. After repeated use, these components may also become obstructed by deposits, such as sediment or beverage residual. Accordingly, it is important to regularly clean the devices to avoid contaminations and potential safety hazards.

There is thus a need for a beverage dispenser including a self-cleaning system that automatically cleans itself for immediate reuse without subsequent beverage contamination.

### SUMMARY OF THE INVENTION

In an embodiment, a method and system for cleaning a beverage dispensing device are disclosed. The method comprises activating a beverage pump coupled to a beverage reservoir, wherein the beverage pump is configured to pump contents of the beverage reservoir to a discharge nozzle. The method further comprises determining that a fill level of the beverage reservoir is below a first predetermined fill level, and activating a cleaning pump coupled to a cleaning reservoir, wherein the cleaning pump is configured to pump contents of the cleaning reservoir to the beverage reservoir. The method further comprises deactivating the cleaning pump based on the contents of the cleaning reservoir filling the beverage reservoir to at least the second predetermined fill level, activating the beverage pump on the deactivation of the cleaning pump, determining that the fill level of the beverage reservoir is below the first predetermined fill level, deactivating the beverage pump a predetermined amount of time after the determination that the fill level of the beverage reservoir is below the first predetermined level, and entering a ready state.

In some embodiments, the contents of the cleaning reservoir comprise water and/or a cleaning solution. In one embodiment, the method further comprises determining that a solution cleaning setting is enabled. Deactivating the cleaning pump may further comprise deactivating the cleaning pump after a predetermined duration that corresponds to filling the beverage reservoir with the contents of the cleaning reservoir to the second predetermined fill level, the second predetermined level corresponding to the solution cleaning setting being enabled. In another embodiment, the method further comprises determining that a solution cleaning setting is not enabled. Deactivating the cleaning pump may further comprise deactivating the cleaning pump after a predetermined duration for a water-only cleaning setting.

In some embodiments, activating the beverage pump based on the deactivation of the cleaning pump further comprises recirculating the contents filling the beverage reservoir through a first flow pathway back to the beverage reservoir for a predetermined number of recirculation cycles and discharging the contents filling the beverage reservoir through a second flow pathway after the predetermined number of recirculation cycles has completed.

In an embodiment, the method further comprises detecting that a content fill level in the beverage reservoir has reached a threshold and activating the beverage pump based on the detection.

In some embodiments, the ready state allows the beverage dispensing device to accept user commands via an input device or user interface

According to one embodiment, the system comprises a beverage reservoir, wherein the beverage reservoir comprises a container coupled to a cooling system. The system further comprises a beverage pump coupled to the beverage reservoir, wherein the beverage pump is configured to pump contents of the beverage reservoir to the cooling system. The system further comprises a sensor configured to detect whether the beverage reservoir is empty, a cleaning reservoir comprising a container, and a cleaning pump coupled to the cleaning reservoir, wherein the cleaning pump is configured to pump contents of the cleaning reservoir to the beverage reservoir. The system further comprises a liquid sensor configured to detect whether the beverage reservoir is below a predetermined fill level and to generate a signal corresponding to the detection, and a programmable circuit board configured to receive the signal from the liquid sensor and control operation of the beverage pump based on the signal.

In one embodiment, the liquid sensor may be configured to detect liquid content in the beverage reservoir and transmit a not empty signal to the programmable circuit board based at least in part on the liquid content being greater than or equal to the predetermined fill level. The programmable circuit board may be configured to activate the beverage pump based on the not empty signal. In another embodiment, the liquid sensor may be configured to transmit an empty signal to the programmable circuit board based at least in part on the liquid content being below the predetermined fill level. The programmable circuit board may be configured to deactivate the beverage pump based on the empty signal.

The system may further comprise a sputter device. The sputter device may include an inlet coupled to the beverage reservoir. The sputter device may be configured to receive the contents of the beverage reservoir at the inlet and discharge the contents of the beverage reservoir via an outlet. The sputter device may comprise a drum and an outlet. The sputter device may include retaining features at edges of the drum that lead to the outlet. The retaining features may comprise raised surfaces configured to retain residual content of the beverage reservoir.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates a beverage dispensing device according to an embodiment.

FIG. 2A illustrates a schematic of components within a beverage dispensing system according to an embodiment.

FIG. 2B illustrates a schematic of components within a beverage dispensing system according to another embodiment.

FIG. 3 illustrates a cutaway view of a dispensing portion of a beverage dispensing device according to an embodiment.

FIG. 4 illustrates a cross-section view of a sputter device according to an embodiment.

FIG. 5 illustrates another cross-section view of a sputter device according to an embodiment.

FIG. 6 illustrates a sputter device according to another embodiment.

FIG. 7 illustrates a flowchart diagram of a boot program sequence for a beverage dispensing device according to an embodiment.

FIG. 8 illustrates a flowchart diagram of a dispensing program sequence for a beverage dispensing device according to an embodiment.

FIG. 9 illustrates a flowchart diagram of a cleaning program sequence for a beverage dispensing device according to an embodiment.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. The following detailed description is, therefore, not intended to be taken in a limiting sense.

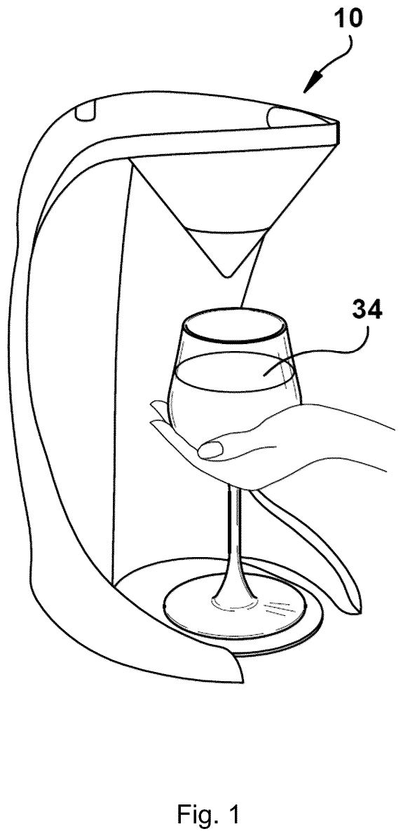

The technology described herein may comprise any type of beverage making or dispensing device, such as a single-serve wine dispensing device 10, as illustrated in FIG. 1. The device 10 may include features for dispensing wine or other beverages including chilling (and warming), aerating, serving, and preserving the wine or other beverage. The device 10 may utilized with a pre-filled beverage pouch. The beverage pouch may hold a beverage product to provide an appropriate amount of preservation for the contents of the pouch and is mechanically openable.

The device 10 may include a pouch loading slot or opening for accepting a beverage pouch. A head of device 10 may house inner workings of the device 10, such as electronics and circuitry. The device 10 may also include a user interface positioned at the front of the head at the top end of the device 10. The user interface may comprise a simple one-touch button, but could comprise multiple buttons, light emitting diodes (LEDs), speakers or other interfaces, such as a touch screen. A recess is also provided in the center of the front of the housing for accepting a wine glass 34 and for dispensing wine into the wine glass. The recess is positioned directly under the head and is sized to accept one or more standard wine glass sizes. The recess may also or alternatively be configured for accepting any other type of glass or container.

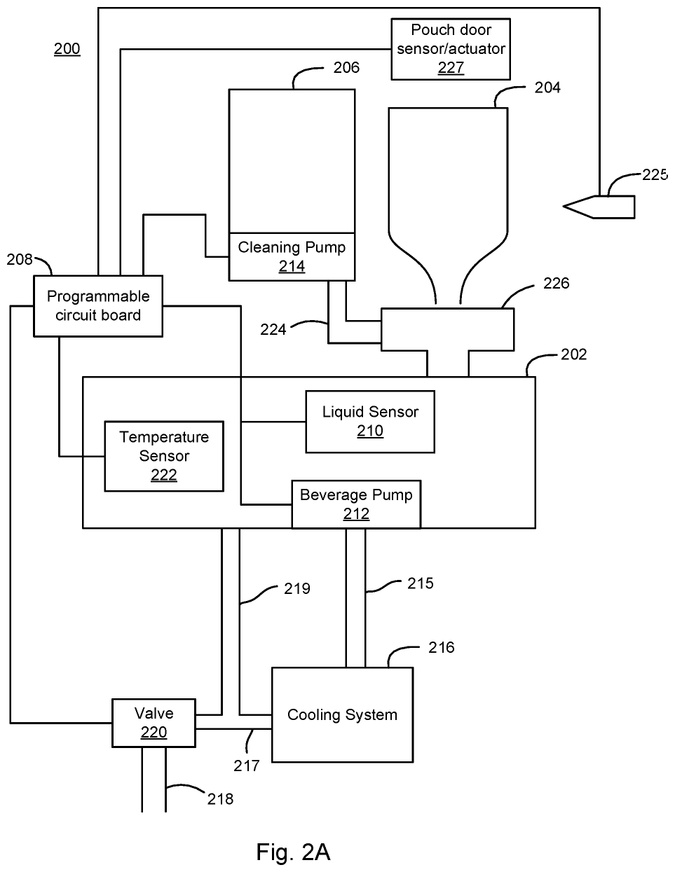

FIG. 2A presents a schematic of example components within a beverage dispensing system according to an embodiment. Beverage dispensing system 200 comprises beverage reservoir 202, cleaning reservoir 206, programmable circuit board 208, cooling system 216, discharge nozzle 218, valve 220, spray nozzle 224, pouch opener/cutter 225, hopper 226 and pouch door sensor/actuator 227. In some embodiments, pouch door sensor/actuator 227 may comprise separate sensor and actuator components. Beverage reservoir 202 may comprise a container for storing beverage received from a beverage pouch 204. Contents from the beverage pouch 204 may be collected by hopper 226 and funneled into beverage reservoir 202.

The beverage reservoir 202 is coupled to a cooling system 216 via tubing 215. The beverage reservoir 202 includes a beverage pump 212 configured to pump contents of the beverage reservoir 202 to the cooling system 216 via tubing 215. The cooling system 216 aids in the cooling or heating of a beverage and may include radiator fans, a radiator pump or other cooling components. Beverage stored in the beverage reservoir 202 may travel to the cooling system 216 via tubing 215, through the cooling system 216 and return to the beverage reservoir 202 via tubing 217 and tubing 219. The beverage may then be pumped back to the cooling system 216 by the beverage pump 212 via tubing 215 for additional cooling as needed until such time that the beverage stored in beverage reservoir 202 reaches a desired temperature.

The beverage pump 212 may be controlled by the programmable circuit board 208 based on a temperature of the beverage detected by temperature sensor 222. Temperature sensor 222 is installed within the beverage reservoir 202 to measure the temperature of the beverage to determine when it is ready to dispense. Programmable circuit board 208 may provide a signal to the valve 220 to open when the temperature reaches a desired level. Once the desired temperature is reached, the valve 220 may open and allow the beverage to flow from the beverage reservoir 202 or cooling system 216 through valve 220 via tubing 217 to the discharge nozzle 218 to be dispensed.

FIG. 2B presents a schematic of example components within a beverage dispensing system according to another embodiment. The embodiment of FIG. 2B operates in a similar manner to that described above for the embodiment of FIG. 2A, except that in FIG. 2B, a valve 221 is disposed between tubing 217 and tubing 219 to control the flow of beverage from cooling system 216 back to reservoir 202 via tubing 217 and tubing 219. In this embodiment, valve 221 may comprise a 3-way value that is configured to control flow between cooling system 216 and beverage reservoir 202 via tubing 217 and tubing 219, to control flow between cooling system 216 and discharge nozzle 218 via tubing 217 and to control flow between beverage reservoir 202 and discharge nozzle 218 via tubing 219.

In the embodiment of FIG. 2B, programmable circuit board 208 may provide a signal to the valve 221 to open one or more flow pathways as needed. For example, while the beverage is being cooled to the desired temperature, the programmable circuit board 208 may provide a signal to the valve 221 to open a flow pathway from the tubing 217 to the tubing 219 based on an activation of beverage pump 212 to allow fluid to flow through the cooling system 216 and back to beverage reservoir 202. When the beverage is ready for dispensing, the programmable circuit board 208 may provide a signal to the valve 221 to open a flow pathway between tubing 217 and discharge nozzle 218 to allow the beverage to flow from the cooling system 216 to the discharge nozzle 218, to open a flow pathway between tubing 219 and discharge nozzle 218 to allow the beverage to flow from beverage reservoir 202, or both, to discharge the beverage. In some embodiments, when the beverage is ready for dispensing, the programmable circuit board 208 may provide a signal to the valve 220 to only open the flow pathway between tubing 217 and discharge nozzle 218 such that beverage pump 216 may utilized to pump the beverage from the beverage reservoir 202 to the discharge nozzle 218 via the tubing 215, the cooling system 216 and the tubing 217 for dispensing by the discharge nozzle 218.

A liquid sensor 210 is installed within or adjacent to the beverage reservoir 202 and is configured to detect a liquid fill level within the beverage reservoir 202. For example, the liquid sensor 210 may be configured to detect one or more of whether the beverage reservoir 202 is empty, whether the beverage reservoir 202 is filled to a predetermined fill level with a beverage, whether the beverage reservoir 202 is filled to a predetermined fill level with water or a cleaning solution or whether the beverage reservoir 202 is filled to any other liquid fill level by a beverage, water, cleaning solution or other liquid. In some embodiments, liquid sensor 210 comprises multiple liquid sensors 210 that may perform one or all of the above functions.

In an example, the liquid sensor 210 may comprise a conductance sensor including two metal leads placed at the bottom of the beverage reservoir 202. When liquid is present, an electrical current may pass between the two metal leads therefore closing a circuit on the liquid sensor 210 to generate a not empty signal to the programmable circuit board 208. Conversely, no liquid present in the beverage reservoir 202 may cause the circuit on the liquid sensor 210 to be open, thus generating no signal (or an empty signal) to the programmable circuit board 208.

In another example, the liquid sensor 210 may comprise a conductance sensor including two metal leads placed at a predetermined fill level of the beverage reservoir 202. When liquid is filled to the predetermined fill level, an electrical current may pass between the two metal leads therefore closing a circuit on the liquid sensor 210 to generate a fill level signal to the programmable circuit board 208. Conversely, when liquid is not filled to the predetermined fill level in the beverage reservoir 202, the circuit on the liquid sensor 210 may be open, thus generating no signal (or a not filled signal) to the programmable circuit board 208 that indicates that the liquid has not been filled to that fill level. The predetermined fill level may comprise, for example, a desired maximum fill level, a target fill level or any other fill level.

Multiple predetermined fill levels may also or alternatively be detected by liquid sensor 210. For example, liquid sensor 210 may comprise multiple liquid sensors 210 each located at a different predetermined fill level including, for example, the bottom or empty fill level, a desired maximum fill level, and any other fill level between the empty fill level and the desired maximum fill level. As the liquid fills the beverage reservoir 202 above each of the predetermined fill levels, the corresponding liquid sensor 210 may generate a fill level signal that corresponds to that fill level.

While described above as comprising a conductance sensor, liquid sensor 210 may also or alternatively comprise other types of sensors capable of detecting liquid fill levels. Some example sensors that may also or alternatively be utilized include capacitance sensors, float sensors, hall sensors, ultrasonic sensors, inductance sensors or any other sensor. In one example, a single ultrasonic liquid sensor 210 may be utilized to detect some or all of the above-described fill levels, e.g., based on the reflection or refraction of ultrasonic waves from the beverage in the beverage reservoir 202.

The programmable circuit board 208 may receive a signal indicative of a presence of liquid content in beverage reservoir 202 from the liquid sensor 210. The signal indicative of the presence of liquid content may be used by programmable circuit board 208 to control operation of beverage pump 212. For example, the beverage pump 212 may be activated or remain on by programmable circuit board 208 based on the receipt of the signal from liquid sensor 210 that indicates that there is liquid content in beverage reservoir 202 at a particular fill level. Conversely, the beverage pump 212 may be deactivated by programmable circuit board 208 based on the receipt of the signal from liquid sensor 210 that indicates that the beverage reservoir 202 is empty, e.g., based on liquid sensor 210 not detecting liquid in beverage reservoir 202. Valves 220/221 may also receive a signal from the programmable circuit board 208 to open or close pathways through the valves 220/221 based on the signal received by programmable circuit board 208 from liquid sensor 210 detecting the presence or absence of liquid content in beverage reservoir 202. The valves 220/221 may also or alternatively be controlled by programmable circuit board 208 based on the receipt by programmable circuit board 208 of a user input from the user interface, e.g., a signal generated by the press of a button or other interface component of the user interface corresponding to the dispensing of the beverage.

Cleaning reservoir 206 may comprise a container for storing water, a cleaning solution or another liquid that can be used for rinsing beverage pathways of the system 200. Example cleaning solutions may comprise a vinegar-based solution, an alcohol based-solution, a one-step cleaning solution or any other cleaning solution. To clean the beverage pathways, a user may press an activation button to send a signal to programmable circuit board 208 to run a cleaning cycle program. The cleaning cycle program may comprise activating the cleaning pump 214 to direct water or cleaning solution from the cleaning reservoir 206 to the spray nozzle 224. The water or cleaning solution may be sprayed from the spray nozzle 224 into the hopper 226 such that the water or cleaning solution ends up in the beverage reservoir 202. In another embodiment, the cleaning reservoir 206 may be coupled to the beverage reservoir 202 to allow for spraying the water or cleaning solution directly into the beverage reservoir 202 from cleaning reservoir 206.

In some embodiments, more than one type of cleaning may be available, and the user may select the type of cleaning to be performed, e.g., water cleaning, cleaning solution cleaning, or cleaning with any other liquid, e.g., via the user interface. As an example, in some embodiments, cleaning reservoir 206 may comprise more than one reservoir where, for example, one reservoir contains water, one reservoir contains a cleaning solution, etc., and the water or cleaning solution may be pumped into the beverage reservoir 202 based on the user selection. In some embodiments, for example, where the beverage dispensing device is connected to a water inlet, e.g., a building water supply, water cleaning may utilize the water inlet and cleaning using the cleaning solution may utilize cleaning solution stored in the cleaning reservoir 206.

The programmable circuit board 208 may activate the beverage pump 212 to pump the water or cleaning solution from the beverage reservoir 202 to the cooling system and open the valves 220/221 to dispense the water or cleaning solution out of the discharge nozzle 218, where it can be collected in a glass and disposed of. The cleaning cycle may be used if different types of beverage are dispensed from the system 200, so that the beverages do not mix. The cleaning cycle can also be used at the end of the day after the last usage to rinse the system 200 or at any other time.

The cleaning cycle may also or alternatively comprise recirculating the water or cleaning solution one or more times from beverage reservoir 202 through cooling system 216 and back to beverage reservoir 202 before dispensing, e.g., via tubing 215, tubing 217, tubing 219 and valve 221 (FIG. 2B) if valve 221 is in the flow pathway. The recirculation may be utilized to increase contact time of the water or cleaning solution with the surfaces of beverage reservoir 202, tubing 215, 217 and 219, cooling system 216 and valve 221 for improved killing of bacteria/virus/mold or other contaminants. The number of times that the water or cleaning solution is recirculated may be determined based on a variety of factors including, for example, when the last cleaning cycle occurred, the type of beverage that was last dispensed, sensor readings within the beverage reservoir 202 or other sensor readings, humidity levels of the environment, temperature levels of the environment or any other factor.

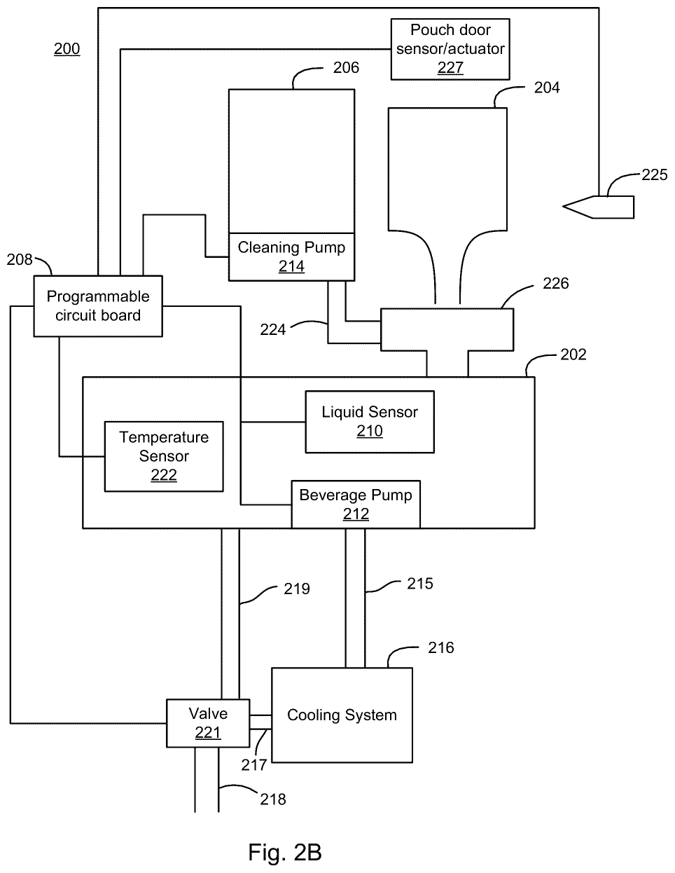

FIG. 3 presents a cutaway view of a dispensing portion of a beverage dispensing device according to an embodiment. The depicted dispensing portion of a beverage dispensing device comprises a housing 300 including a sputter device 302. The sputter device 302 may comprise a device that mitigates the appearance of water (e.g., post-cleaning cycle) or leftover beverage when dispensing beverages that may be undesirable (e.g., particularly red wine). Sputter device 302 is coupled with tubing from a beverage flow path or the beverage reservoir 202 at an inlet 304. Contents from the beverage reservoir 202 may be pumped to and received by the sputter device 302 at the inlet 304. The contents may fill the sputter device 302 and be discharged from an outlet. The sputter device 302 is located above a dispensing region and under the programmable circuit board 208 that controls the operations of the beverage dispensing device.

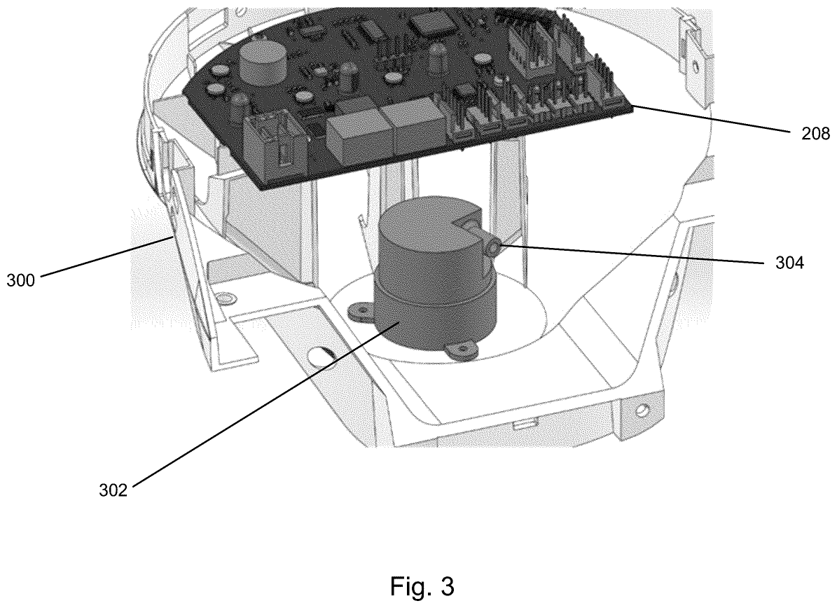

FIG. 4 presents a cross-section view of a sputter device according to an embodiment of the present invention. Sputter device 302 may include a drum 402 and an outlet 404. Drum 402 may comprise a reservoir for receiving beverage from a beverage flow path. Outlet 404 may comprise a funneled spout at the bottom of drum 402 for carrying the beverage from the drum 402 to outlet 404. The sputter device 302 may prevent residual water (e.g., from a self-cleaning cycle) or leftover beverage from being dispensed on its own by allowing the residual water or leftover beverage to mix with a beverage to be dispensed.

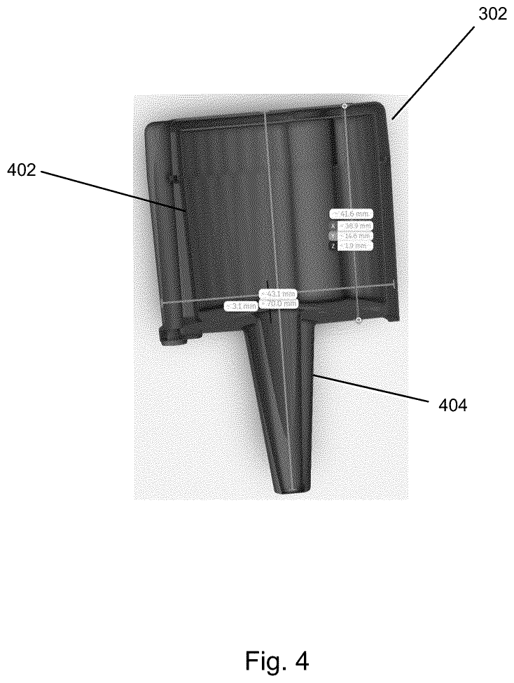

FIG. 5 another cross-section view of a sputter device according to an embodiment of the present invention. The sputter device 302 further includes retaining features 406. The retaining features 406 may comprise raised surfaces, for example, in a shape of a chamfer or bevel, at the edges of the drum 402 that lead to the outlet 404. Retaining features 406 create slight lips to retain residual water or leftover beverage expelled from the beverage flow path. The residual water or leftover beverage held by the retaining features 406 may be allowed to eventually exit the sputter device 302 when additional liquid is added to drum 402, thereby causing mixing with the residual water or leftover beverage and causing the amount of liquid in drum 402 to overcome the retaining features 406.

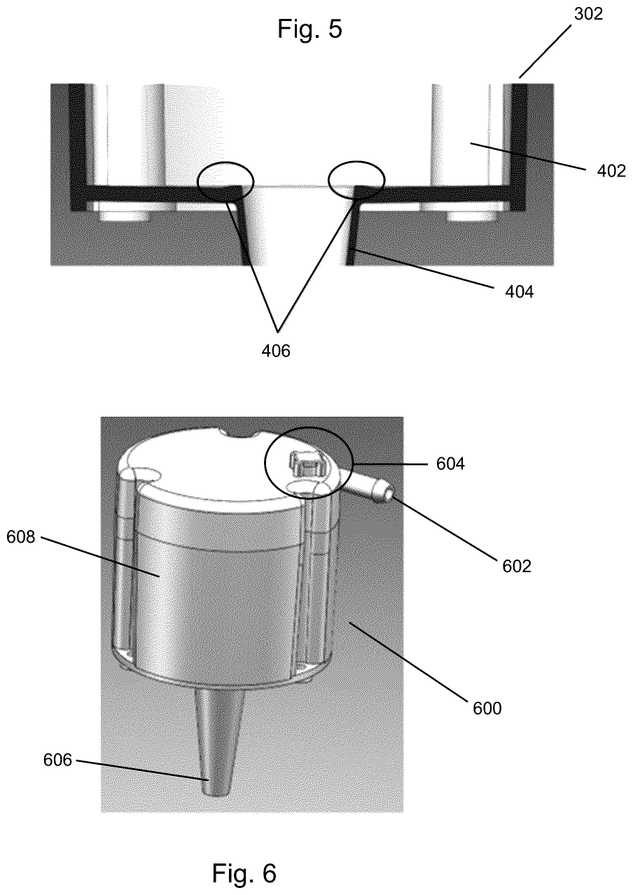

FIG. 6 illustrates a sputter device according to another embodiment of the present invention. Sputter device 600 comprises an inlet 602, vent 604, outlet 606, and drum 608. Features and functionality of sputter device 600 may be substantially similar to sputter device 302 except for the addition of vent 604. Vent 604 may comprise an opening for the relief or passage of air into drum 608 to facilitate flow of liquid out of outlet 606.

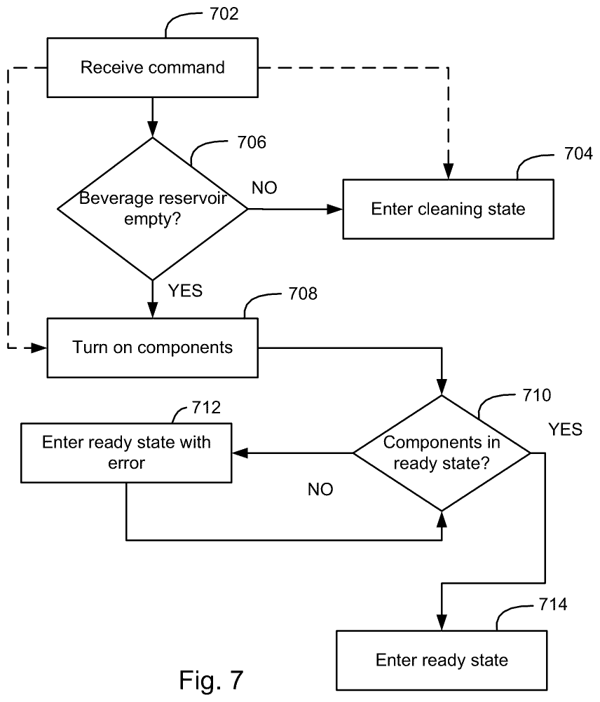

With reference to FIG. 7, an example process of a boot program sequence for a beverage dispensing device according to an embodiment will be described. The beverage dispensing device may be activated by a press of button, for example, an on/off or power button. In some embodiments, the beverage dispensing device may also or alternatively be active by the press of a clean button that powers on the beverage dispensing device and initiates a cleaning cycle. The beverage dispensing device may include a computing device, e.g., the programmable circuit board 208, that is configured to execute the boot program sequence.

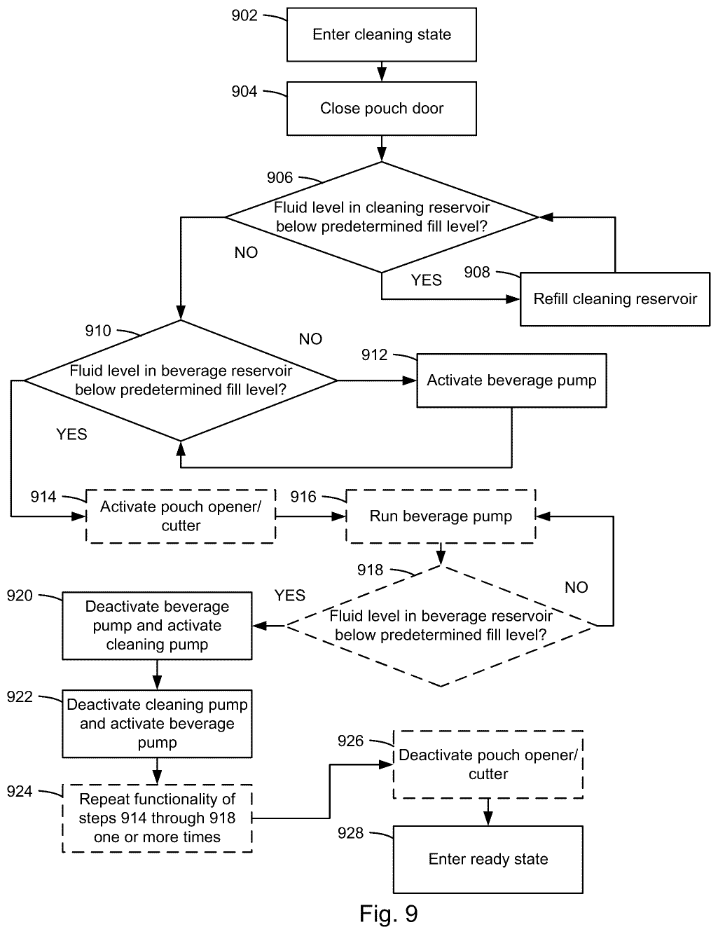

At step 702, a command is received by the computing device, e.g., in response to the power button or the clean button being pressed. In some embodiments, receipt of the command may cause the beverage dispensing device to enter a cleaning state at step 704 regardless of whether or not the beverage dispensing device was previously cleaned, e.g., as denoted by the dashed line from step 702 to step 704. In some embodiments, the receipt of the command may cause the computing device to determine whether or not the beverage reservoir 202 is empty at step 706, e.g., using the liquid sensor 210, with the computing device causing the beverage dispensing device to enter the cleaning state at step 704 in response to the beverage reservoir 202 not being empty. The cleaning state may comprise a cleaning procedure that is initiated by the computing device to clean and dispose of leftover beverage in the beverage reservoir 202. The cleaning state and process is described in further detail with respect to the description of FIG. 9.

Referring back to step 706, if the beverage reservoir 202 is empty, components of the beverage dispensing device are turned on by the computing device at step 708. In some embodiments, the computing device may alternatively turn on the components of the beverage dispensing device without determining whether the beverage reservoir 202 is empty, e.g., as denoted by the dashed line from step 702 to step 708. In such an embodiment, the method may proceed to step 708 regardless of whether the beverage reservoir 202 is empty or not. The components may include a pouch door sensor/actuator 227, radiator fans, radiator pump, intake fans, the pouch opener/cutter 225 or any other component of the beverage dispensing device such as those mentioned above.

At step 710, the computing device determines whether the components are in a ready state. For example, the computing device may detect whether the pouch door is closed, e.g., using the pouch door sensor/actuator 227, detect whether the pouch opener/cutter 225 is retracted, detect whether the sensors, fans and pumps are functioning properly and detect whether any other component is in the ready state. As an example, the computing device may determine that the cooling system is not in the ready state if the radiator pump is not functioning, the temperature of the cooling system is not decreasing, or any other component of the cooling system is not functioning properly. As another example, the computing device may determine that the liquid sensor 210 is not in the ready state if a signal received by the liquid sensor 210 does not match an expected signal, e.g., an empty signal, a not empty signal or any other expected signal.

If any components are not in the ready state, a corrective action may be performed. For example, the computing device may close the pouch door using the pouch door sensor/actuator 227, the computing device may retract the pouch opener/cutter 225 or perform any other corrective action. In some embodiments, if any components are not in the ready state, the computing device may enter a ready state with error at step 712. The ready state with error may comprise the computing device being operable to accept user commands via an input device and/or user interface and return to step 710 upon resolution of the error condition, e.g., pouch door is not closed. The computing device may indicate the error to the user and inform the user of how to resolve the issue, e.g., close the pouch door, via the user interface. In some embodiments, the computing device may indicate that the user should activate the cleaning state, e.g., if the pouch opener/cutter 225 is not retracted or another component that may require cleaning is not in the ready state.

Returning to step 710, if the components are in the ready state, the computing device enters the ready state at step 714. The ready state may allow the computing device to accept user commands via the input device and/or user interface and be ready to dispense a beverage.

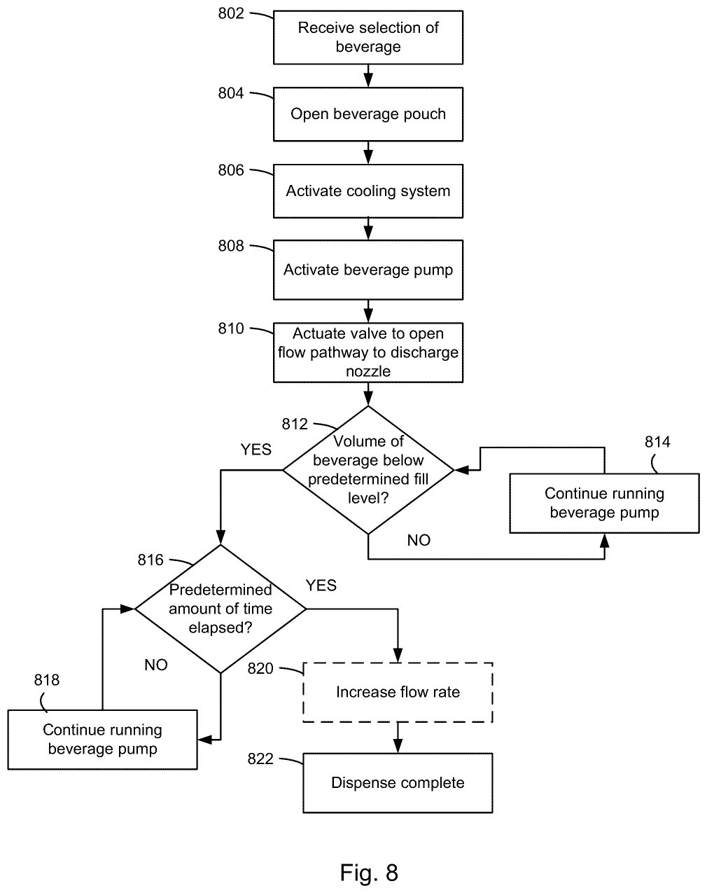

With reference to FIG. 8, an example process for dispensing a beverage according to an embodiment will be described.

At step 802, the computing device receives a selection of a beverage to dispense, e.g., from a user via the user interface. In some embodiments, the selection may comprise selecting a type of beverage, brand of beverage or any other selection. For example, the selected type or brand of beverage may correspond to a desired temperature of the beverage when dispensed. Non-limiting examples of the selected type comprise white wine, red wine, rose wine, any other type of wine or any other type of beverage. In a case where the beverage dispensing device stores multiple types or brands of beverage, the selection of the beverage may comprise the selection of one of the available beverages.

In some embodiments, the selection of a beverage may occur before or after the user has inserted a beverage pouch into the beverage dispensing device, e.g., via the pouch door. In other embodiments, the computing device may request that the user open the pouch door, insert the beverage pouch and close the pouch door after selection of the beverage, e.g., via the user interface. In some embodiments, computing device may open the pouch door for the user after selection of the beverage and await a closure of the pouch door before proceeding with the dispensing process, e.g., using the pouch door sensor/actuator 227. In some embodiments, the selection of the beverage may comprise the selection that a beverage be dispensed where, for example, the type, brand or other characteristics may be determined based on the beverage pouch inserted into the beverage dispensing device, e.g., by scanning the beverage pouch for identifying information such as, e.g., text, logos, lettering, a product code, bar code, QR code, an RFID tag or any other identifying information that may be utilized to determine the type or brand of the beverage. For example, the beverage dispensing device may comprise a sensor that is configured to determine the type or brand of the beverage based on the inserted beverage pouch, e.g., a camera, infrared reader, bar code reader, QR code reader, RFID reader or any other sensor.

At step 804, the computing device actuates the pouch opener/cutter 225 to puncture or otherwise open the beverage pouch. Actuation of the pouch opener/cutter 225 causes the beverage contained within the beverage pouch to enter the beverage reservoir.

At step 806, the computing device activates the cooling system 216 to prepare the cooling system 216 for receiving the beverage for cooling.

At step 808, the computing device activates the beverage pump 212 to pump the beverage to the cooling system 216. In some embodiments, the beverage pump 212 may be activated at a duty cycle that corresponds to characteristics of the selected beverage. The duty cycle controls the flow rate the beverage. The duty cycle may be adjusted based on the temperature of the beverage in the winesink, e.g., as sensed by the temperature sensor 222 in the beverage reservoir 202, and the temperature of the cooling system 216 to adjust the flow rate of the beverage.

In conjunction with activating the beverage pump, the computing device may also actuate the valve 220/221 to control the flow of the beverage through the flow pathways between the cooling system 216, discharge nozzle 218 and the beverage reservoir 202.

For example, in an embodiment where the beverage is to be recirculated through the cooling system 216 and back to the beverage reservoir 202, the computing device may actuate the valve 220/221 to inhibit flow to discharge nozzle 218 while allowing flow back to beverage reservoir 202. In the example of FIG. 2A, the actuation may comprise closing the valve 220. In the example of FIG. 2B, the actuation may comprise closing the pathway through the valve 221 from tubing 217 to discharge nozzle 218 while opening the pathway from tubing 217 to tubing 219 and beverage reservoir 202. If valve 220/221 is already in the target state, no actuation may be necessary.

Once the temperature of the beverage in the beverage reservoir 202 reaches a predetermined temperature, the computing device actuates valve 220/221 to open the flow pathway to discharge nozzle 218 to dispense the beverage at step 810. In some embodiments, the predetermined temperature may be a temperature that is higher than the target temperature, for example, by an amount that the beverage would be cooled by the cooling system 216 to dispense the beverage at the target temperature from discharge nozzle 218 via the cooling system 216. In some embodiments, the predetermined temperature may be at or below the target temperature where, for example, the beverage pump 212 may be shut off and the beverage may be dispensed from the beverage reservoir 202 via tubing 219 to discharge nozzle 218 without further cooling to achieve the target temperature at discharge. For example, the beverage may be allowed to drain out of the beverage reservoir via tubing 219, e.g., by gravity, or be pumped from beverage reservoir 202 via tubing 219 by another pumping mechanism.

In an embodiment where the beverage is to be dispensed without recirculation, e.g., directly from the beverage reservoir 202 through the cooling system 216 and out the discharge nozzle 218, the computing device may activate beverage pump at step 808 and actuate valve 220/221 to open the pathway from tubing 217 to discharge nozzle 218 at step 810 at the same or approximately the same time. In this embodiments, the duty cycle of the beverage pump 212 may be adjusted based on the temperature of the beverage in the beverage reservoir 202, e.g., as detected by temperature sensor 222, and the temperature of the cooling system 216 to adjust the flow rate such that the beverage will exit the discharge nozzle 218 via the cooling system 216 at the target temperature. For example, the flow rate of the beverage through the cooling system 216 may be adjusted based on the temperature difference between the temperature of the beverage as sensed by temperature sensor 222 in beverage reservoir 202 and the temperature of the cooling system 216, based on an expected temperature loss of the beverage as it travels between the cooling system 216 and the discharge nozzle 218 and based on the target temperature at which the beverage is to be dispensed out of the discharge nozzle 218.

At step 812, the computing device determines whether the volume of the beverage in the beverage reservoir 202 is below a predetermined liquid fill level, e.g., the empty fill level or another fill level, for example, using liquid sensor 210 as described above. If the volume is not below the predetermined fill level, the computing device continues running the beverage pump to dispense the beverage at step 814 and the process returns to step 812. If the volume is below the predetermined fill level, the process proceeds to step 816.

At step 816, the computing device determines whether a predetermined amount of time has elapsed after the computing device determined that the volume of the beverage in the beverage reservoir is below the predetermine fill level, e.g., 5 seconds, 10 seconds, 15 seconds or any other amount of time. If the predetermined amount of time has not elapsed, the computing device continues running the beverage pump 212 at step 818 and the process returns to step 816. If the predetermined amount of time has elapsed, the process proceeds to step 820.

At step 820, in some embodiments, the flow rate of the beverage pump 212 may be increased, e.g., by adjusting the duty cycle, based on the determination by the computing device that the predetermined amount of time has elapsed, e.g., to clear residual beverage from the beverage reservoir 202, cooling system 216, tubing 217, discharge nozzle 218, tubing 219 and valve 220/221 as much as possible. In some embodiments, the flow rate may be increased before the predetermined amount of time has elapsed, e.g., based on the determination by the computing device that the volume of the beverage in the beverage reservoir 202 is below the predetermined fill level.

At step 820, the computing device determines that the dispensing is complete, turns off the beverage pump 212, closes the valve 220/221 and opens the pouch door, e.g., using pouch door sensor/actuator 227. The user may then dispose of the used beverage pouch, replace the used beverage pouch with a new beverage pouch, initiate a cleaning process or perform other actions.

With reference now to FIG. 9, an example process for cleaning the beverage dispensing device according to an embodiment will be described.

At step 902, the computing device enters the cleaning state, e.g., via step 704 of FIG. 7, due to a press of a power on/off button, a cleaning button of for any other reason.

At step 904, the computing device closes the door if open, e.g., using the door sensor/actuator 227, or requests that the user close the door via the user interface.

At step 906, the computing device checks the fluid level of the cleaning reservoir 206, e.g., using a liquid sensor similar to liquid sensor 210. If the fluid level is below a predetermined fill level in the cleaning reservoir 206, the computing device may cause the cleaning reservoir to be refilled with water or a cleaning solution at step 908. For example, if the cleaning reservoir is connected to a fill line such as a water line or a fill line to a cleaning solution, the computing device may open a valve to allow the cleaning reservoir 206 to receive the water or cleaning solution via the fill line. If user action is required to refill the cleaning reservoir 206, the computing device may instruct the user to fill the cleaning reservoir 206 with water or a cleaning solution, e.g., via the user interface. The process may then return from step 908 to step 906.

If the computing device determines that the fluid level in the cleaning reservoir 206 is at or above the predetermined fill level, the process proceed to step 910.

At step 910, the computing device determines whether the fill level in the beverage reservoir 202 is below a predetermined fill level, e.g., the empty fill level or another predetermined fill level, using liquid sensor 210. If the fill level in the beverage reservoir 202 is not below the predetermined fill level, the process proceeds to step 912. If the fill level in the beverage reservoir 202 is below the predetermined fill level, the process proceeds to step 914.

At step 912, the computing device activates the beverage pump 212 to drain the beverage reservoir 202. In some embodiments, the beverage pump 212 may be run until the liquid sensor 210 indicates that the fill level in the beverage reservoir 202 is below the predetermined fill level. In some embodiments, the beverage pump 212 may continue to be run after the liquid sensor 210 indicates that the fill level in the beverage reservoir 202 is below the predetermined fill level for an additional predetermined amount of time, e.g., 5 seconds, 10 seconds, 15 seconds or any other amount of time. The process then returns to step 910.

At step 914, the computing device actuates the pouch opener/cutter 225, e.g., to extend the cutter or other opening mechanism. In some embodiments, steps 914-918 may be optional steps that are performed in certain circumstances, e.g., during a power on/off clean process. In other embodiments, steps 914-918 may be performed during each cleaning process.

At step 916, the computing device runs the beverage pump 212 at a predetermined flow rate for a predetermined amount of time. As an example, the predetermined flow rate may be a flow rate that is slower than the flow rate during normal operation for cooling or dispensing beverages, e.g., by using a lower duty cycle. In some embodiments the predetermined amount of time may be 5 seconds, 10 seconds, 15 seconds or any other predetermine amount of time.

At step 918, the computing device determines whether the fill level of the beverage reservoir 202 is below the predetermined fill level, e.g., using liquid sensor 210. If the fill level of the beverage reservoir 202 does not stay below the predetermined fill level, the process returns to step 916, and the computing device continues to run the beverage pump 212 until the fill level of the beverage reservoir 202 is below the predetermined fill level. In some embodiments, the duty cycle for step 916 may be increased, e.g., to the duty cycle for step 912 or another duty cycle, if fluid is detected in the beverage reservoir 202.

Referring back to step 918, if the fill level of the beverage reservoir 202 stays below the predetermined fill level, the process proceeds to step 920.

At step 920, the computing device turns off the beverage pump 212 and activates and runs the cleaning pump 214 for a predetermined amount of time. The predetermined amount of time may be an amount of time that is calibrated to fill the beverage reservoir 202 to a predetermined fill level. As an example, if the beverage reservoir 202 is configured to store a first volume of liquid, e.g., 187 ml or any other volume, and the wine pouches are configured to hold a second volume of liquid that is smaller than the first volume of liquid, e.g., 125 ml or any other volume, the computing device may activate the cleaning pump 214 for an amount of time that fills the beverage reservoir 202 with a third volume of liquid that is greater than or equal to the second volume of liquid and less than or equal to the first volume of liquid, e.g., 150 ml or any other volume. For example, the volume of liquid, e.g., water or the cleaning solution, may be greater than that filled by a beverage pouch to ensure that the water or cleaning solution covers at least the same volume in the beverage reservoir 202 as that filled by the beverages that were dispensed. In some embodiments, the predetermined amount of time to run the cleaning pump 214 may correspond to a selection of the cleaning liquid by the user, e.g., selecting water cleaning, liquid cleaning or cleaning using another liquid. For example, the target fill level for water cleaning in the beverage reservoir 202 may be different than the target fill level for the cleaning solution or another liquid and the predetermined amount of time to run the cleaning pump 214 may be adjusted accordingly.

At step 922, the computing device turns off the cleaning pump 214 and activates and runs the beverage pump 212. In some embodiments, the computing device may close the pathway to discharge nozzle 218 using valve 220/221 and recirculate the water or cleaning solution from beverage reservoir 202 through cooling system 216, tubing 217 and tubing 219 one or more times followed by an opening of valve 220/221 to discharge the water or cleaning solution through the discharge nozzle 218. In other embodiments, where recirculation is not utilized or selected, the computing device may open the valve 220/221 to discharge the water or cleaning solution through the discharge nozzle 218 when activating the beverage pump 212. Whether or not recirculation is utilized may depend on the configuration of the beverage dispensing device, a user selection on the user interface or on any other factor. As an example, in some embodiments, the user may select to use recirculation cleaning or in-line (non-recirculation) cleaning, e.g., via the user interface. In other embodiments, the computing device may select recirculation or in-line cleaning automatically, e.g., based on the type of cleaning operation (power on/off or user selected cleaning), the number of uses since last cleaning, the type of cleaning liquid or any other factor.

In either case, once the valve 220/221 is opened to the discharge nozzle 218, the computing device runs the beverage pump 212 until the liquid sensor 210 indicates that the beverage reservoir 202 is below a predetermined fill level, e.g., empty or another fill level. In some embodiments, the computing device may run the beverage pump 212 for a further predetermined amount of time after the beverage reservoir 202 is below the predetermined fill level, e.g., 5 seconds, 10 seconds, 15 seconds or any other amount of time.

At step 924, in some embodiments, the functionality of steps 914 through 918 are optionally repeated one or more times where if the fill level of the beverage reservoir 202 stays below the predetermined fill level after the final time, the process proceeds to step 926 instead of 920. In an example embodiment, during a power on or power off cleaning process, the functionality of steps 914 through 920 may be repeated three times while during a user initiated clean cycle, the functionality of steps 914 through 920 may be performed only one time. In other embodiments, the functionality of steps 914 through 920 may be performed any other number of times for each type of cleaning process including zero times, one time, two times, three times or any other number of times.

At step 926, in some embodiments, the computing device actuates pouch opener/cutter 225, e.g., to retract the cutter or other opening mechanism. As an example, in some embodiments, step 926 may only be performed for a power on/off clean process. In other embodiments, step 926 may be performed any time the pouch opener/cutter 225 has been actuated during cleaning to retract the cutter or other opening mechanism.

At step 928, the computing device enters the ready state. In a case where the cleaning process was a power off cleaning process, the computing device may power down the beverage dispensing device. In some embodiments, the computing device may open the pouch door as part of entering the ready state, e.g., by activating the pouch door sensor/actuator 227.

FIGS. 1 through 9 are conceptual illustrations allowing for an explanation of the disclosed embodiments. Notably, the figures and examples above are not meant to limit the scope of the disclosed embodiments to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the disclosed embodiments encompass present and future known equivalents to the known components referred to herein by way of illustration.

It should be understood that various aspects of the disclosed embodiments could be implemented in hardware, firmware, software, or combinations thereof. In such embodiments, the various components and/or steps would be implemented in hardware, firmware, and/or software to perform the functions of the disclosed embodiments. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the disclosed embodiments as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A method, executed by a beverage dispensing device comprising a processor and a memory, for cleaning a beverage dispensing device, the method comprising:
activating, by a computing device, a beverage pump coupled to a beverage reservoir, the beverage pump configured to pump contents of the beverage reservoir to a discharge nozzle;
determining, by the computing device, that a fill level of the beverage reservoir is below a first predetermined fill level;
deactivating, by the computing device, the beverage pump based on the determination that fill level of the beverage reservoir is below the predetermined fill level;
activating, by the computing device, a cleaning pump coupled to a cleaning reservoir, the cleaning pump configured to pump contents of the cleaning reservoir to the beverage reservoir to a second predetermined fill level;
deactivating, by the computing device, the cleaning pump based on the contents of the cleaning reservoir filling the beverage reservoir to at least the second predetermined fill level;
activating, by the computing device, the beverage pump based on the deactivation of the cleaning pump;
determining, by the computing device, that the fill level of the beverage reservoir is below the first predetermined fill level;
deactivating, by the computing device, the beverage pump a predetermined amount of time after the determination that the fill level of the beverage reservoir is below the first predetermined level; and
entering, by the computing device, a ready state.

2. The method of claim 1 wherein the contents of the cleaning reservoir comprise water and/or a cleaning solution.

3. The method of claim 1 further comprising determining that a solution cleaning setting is enabled.

4. The method of claim 3 wherein deactivating the cleaning pump further comprises deactivating the cleaning pump after a predetermined duration that corresponds to filling the beverage reservoir with the contents of the cleaning reservoir to the second predetermined fill level, the second predetermined level corresponding to the solution cleaning setting being enabled.

5. The method of claim 1 further comprising determining that a solution cleaning setting is not enabled.

6. The method of claim 5 wherein deactivating the cleaning pump further comprises deactivating the cleaning pump after a predetermined duration for a water-only cleaning setting.

7. The method of claim 1 wherein activating, by the computing device, the beverage pump based on the deactivation of the cleaning pump further comprises:
recirculating, by the beverage pump, the contents filling the beverage reservoir through a first flow pathway back to the beverage reservoir for a predetermined number of recirculation cycles; and
discharging, by the beverage pump, the contents filling the beverage reservoir through a second flow pathway after the predetermined number of recirculation cycles has completed.

8. The method of claim 1 further comprising:
detecting that a content fill level in the beverage reservoir has reached a threshold; and
activating the beverage pump based on the detection.

9. The method of claim 1 wherein the ready state allows the beverage dispensing device to accept user commands via an input device or user interface.

10. A beverage dispensing system comprising:
a beverage reservoir comprising a container coupled to a cooling system;
a beverage pump coupled to the beverage reservoir, the beverage pump configured to pump contents of the beverage reservoir to the cooling system;
a sensor configured to detect whether the beverage reservoir is empty;
a cleaning reservoir comprising a container;
a cleaning pump coupled to the cleaning reservoir, the cleaning pump configured to pump contents of the cleaning reservoir to the beverage reservoir;
a liquid sensor configured to detect whether the beverage reservoir is below a predetermined fill level and to generate a signal corresponding to the detection; and
a programmable circuit board configured to receive the signal from the liquid sensor and control operation of the beverage pump based on the signal.

11. The beverage dispensing system of claim 10 wherein the liquid sensor is configured to detect liquid content in the beverage reservoir and transmit a not empty signal to the programmable circuit board based in part on the liquid content being above or equal to the predetermined fill level.

12. The beverage dispensing system of claim 11 wherein the programmable circuit board is configured to activate the beverage pump based on the not empty signal.

13. The beverage dispensing system of claim 10 wherein the liquid sensor is configured to transmit an empty signal to the programmable circuit board based in part on the liquid content being below the predetermined fill level.

14. The beverage dispensing system of claim 13 wherein the programmable circuit board is configured to deactivate the beverage pump based on the empty signal.

15. The beverage dispensing system of claim 10 further comprising a sputter device.

16. The beverage dispensing system of claim 15 wherein the sputter device includes an inlet coupled to the beverage reservoir.

17. The beverage dispensing system of claim 15 wherein the sputter device is configured to receive the contents of the beverage reservoir at the inlet and discharge the contents of the beverage reservoir via an outlet.

18. The beverage dispensing system of claim 15 wherein the sputter device comprises a drum and an outlet.

19. The beverage dispensing system of claim 18 wherein the sputter device includes retaining features at edges of the drum that lead to the outlet.

20. The beverage dispensing system of claim 19 wherein the retaining features comprise raised surfaces configured to retain residual content of the beverage reservoir.
